(19) United States
(12) Patent Application Publication
(10) Pub. No.: US 2016/0050962 A1
(43) Pub. Date: Feb. 25, 2016

(54) Preconception/Prenatal/Postnatal Optimal Nutrition System, Compositions and Kits for Use Therein, and Methods of Making and Using Same

(71) Applicant: Nestec S. A., Vevey (CH)

(72) Inventors: Kelly Nicole DAVIES, Westfield, NJ (US); Michael Francis RUPPE, Randolph, NJ (US); Susan Gerberg PAC, West Caldwell, NJ (US); Kathleen Charity REIDY, West Orange, NJ (US); Cheryl Ann CALLEN, Short Hills, NJ (US); Monica Maria BEARDEN, Tomball, TX (US); Shara Lynn AARON, Yardley, PA (US)

(21) Appl. No.: 14/831,397

(22) Filed: Aug. 20, 2015

Related U.S. Application Data
(60) Provisional application No. 62/039,524, filed on Aug. 20, 2014.

(51) Int. Cl. A23L 1/29; A23L 1/303; A23L 2/52; A23L 1/30; A23L 1/308; A23L 1/302; A23L 1/304

(52) U.S. Cl. CPC A23L 1/296; A23L 1/302; A23L 1/303; A23L 1/304; A23L 1/3014; A23L 1/3002; A23L 1/308; A23L 1/30; A23L 1/3008; A23L 2/52; A23V 2002/00

(57) ABSTRACT

A nutrition system for use during a preconception period, during pregnancy, during lactation, and/or during postnatal weight loss is disclosed herein. Also disclosed are compositions and kits for use therein, as well as methods of making and using same. Also disclosed are a range of preconception, prenatal, pregnancy, postnatal, and/or lactation food and/or beverage products, assemblies containing same, and methods of production and use thereof.

### CROSS REFERENCE TO RELATED APPLICATIONS/INCORPORATION BY REFERENCE STATEMENT

The subject application claims benefit under 35 USC §119(e) of provisional application U.S. Ser. No. 62/039,524, filed Aug. 20, 2014; the entire contents of which are expressly incorporated herein by reference.

### STATEMENT REGARDING FEDERALLY SPONSORED RESEARCH AND DEVELOPMENT

Not Applicable.

### BACKGROUND

The first 1,000 days of life (i.e., the 1,000 days represents the time between the start of a woman's pregnancy (i.e. Conception) and her child's second birthday) have recently been recognized as a critical period of growth and development that offers a unique window of opportunity to set the foundation for the child's physical, social/emotional, and intellectual wellbeing and shape healthier and more prosperous futures for children. The right nutrition and/or the optimal nutrient intake during this 1,000 day window can have a profound short- and long-term impact on a child's future growth development, including cognition, and/or mental abilities is also referred to as “Early Life Programming,” “Nutrigenics,” and/or “Developmental Origins of Health and Disease.” Therefore, providing a healthy start and/or improvement in the nutrition of both mothers and children in this 1,000 day window is currently a significant focus of research, in the hopes of ensuring that children can grow up to live healthy and productive lives. Evidence shows that the right nutrition during the 1,000 day window can save more than one million lives each year; significantly reduce the human and economic burden of diseases such as, but not limited to, tuberculosis, malaria, and HIV/AIDS; reduce the risk for developing various non-communicable diseases such as, but not limited to, diabetes and other chronic conditions later in life; and improve an individual's educational achievement. As a result, leading scientists, economists, and health experts agree that improving nutrition during the critical 1,000 day window is one of the best investments that can be made to achieve lasting progress in global health and development (see, for example, 1,000 Days, an initiative launched by the U.S. and Irish Governments in 2010 to promote greater action and investment in maternal and young child nutrition [http://www.thousanddays.org)]).

Optimal nutrition, i.e., a balanced diet that contains appropriate levels of macronutrients and micronutrients to support a healthy pregnancy, metabolic health, and optimal fetal outcomes, is essential during preconception, pregnancy, and lactation periods. Nutritional gaps, both excesses and shortfalls, in a mother's dietary intake and nutritional status, not only during pregnancy but also during a preconception period, as well as during postnatal lactation, and weight loss periods, may impact not only the mother but also the developing fetus or nursing infant. Despite the ongoing research in this area, a sizeable group of women in a preconception period as well as in prenatal/postnatal periods experience excess and/or inadequate dietary intakes of macro- and micro-nutrients, These gaps, nutritional excesses and/ or shortfalls, may be caused by: (i) poor maternal dietary intake of nutrients (which may occur during any of the preconception, prenatal, pregnancy, postnatal, and/or lactation periods); (ii) inadequate or unhealthy dietary patterns (i.e. low consumption of fruits, vegetable, whole grains, low-fat dairy, lean meat; and high consumption of foods with excess calories, saturated fat, added sugars, sodium, and minimal nutritional value) (iii) one or more pre-pregnancy existing health conditions (i.e., obesity, diabetes, etc., and including genetically and/or environmentally related conditions); (iv) increased and or varying nutritional needs during pregnancy and/or lactation; (v) common symptoms that may arise during pregnancy and/or lactation (i.e., nausea, vomiting, fatigue, sleeplessness, constipation, bloating, diarrhea, etc.); and/or (vi) one or more pregnancy-induced health conditions (i.e., gestational diabetes, anemia, hypertension, etc., and including genetically and/or environmentally related conditions).

Furthermore, excess consumption of foods with minimal nutritional value, such as foods that are high in saturated fat, added sugars, added sodium, and low in adequate nutrients; such as essential fats, vitamins and minerals, and dietary fiber may increase the risk of excessive weight gain, gestational diabetes, and/or other sub-optimal metabolic states for the pregnant women. There is considerable concern about Non-Communicable Disease such as diabetes, cardiovascular and cancer, risk being transferred through generations. Epidemiological studies show that children born to mothers with gestational diabetes have a greater susceptibility to metabolic and cardiovascular disease. The main adverse outcome of pregnancy complicated by gestational diabetes is excessive fetal growth. Excessive fetal growth leads to increased birth weight and adiposity, which has been linked with increased risk of common chronic diseases such as type 2 diabetes mellitus, cardiovascular diseases and obesity later in life. Women suffering gestational diabetes and women suffering both gestational diabetes and obesity had twice and three times more probability of having a larger than normal baby (birth weight>90th percentile) or a baby with higher adiposity (% body fat>90^{th} percentile) that women with none of this conditions.

Specific blends of nutrients and probiotics can improve the health of mothers and babies when taken by mothers before conception and throughout pregnancy. What a woman consumes before and during pregnancy may influence the fetal and infant health. The nutrition consumed during conception and pregnancy maintains healthy blood sugar, vitamin and mineral levels, sustains a healthy pregnancy, and promotes the healthy growth and development of her infant.

There are vitamins, minerals, and nutritional supplements directed to pregnant and/or lactating women that are currently commercially available; however, many women struggle to keep vitamins/supplements down, especially during the first trimester of pregnancy. In addition, while the vitamins/supplements may contain a certain amount or dosage of a particular substance, the absorption rate of each vitamin or substance in a supplement may vary, depending on several factors, including but not limited to, the form in which the substance is provided in the vitamin/supplement and other foods/beverages that may be consumed therewith; therefore, the amount of the vitamin/substance absorbed may well be below the intended dosage provided.

Further, multi-vitamin supplements do not provide 100% of all nutrients; for example, but not limited to, calcium and magnesium, choline, so even with a multi-vitamin supplement or vitamin supplement that is kept down, a women still may have nutrient gaps.

Moreover, a typical vitamin/supplement is recommended for consumption by women in all stages of pregnancy/lactation, while different stages of pregnancy/lactation may have varying nutritional needs; therefore, the vitamin/supplement may contain a vitamin/substance that is only required for a particular stage of pregnancy/lactation, but may be consumed by women in a different stage that does not require said vitamin/substance or that dosage of said vitamin/substance. In fact, many of the fortified options currently on the market may not be providing the appropriate nutrients and levels of nutrients for certain stages of pregnancy/lactation. Data from the National Health and Nutrition Examination Survey (NHANES) 2001-2010 were examined to assess food consumption while pregnant/not pregnant and to analyze the dietary differences between pregnant women and non-pregnant women. All women, pregnant and non-pregnant (20-40 years of age), had usual intakes of multiple micronutrients below recommended values for pregnancy and lactation, even with consumption of a prenatal vitamin and mineral supplement. In addition, the nutritional needs may further vary in response to the health of the mother prior to pregnancy and/or conditions encountered during pregnancy/lactation by the mother or child, as described in detail herein above, and the one-size-fits-all products currently on the market do not take these variables into account.

Also, many of the vitamins/supplements are present in bland-tasting, fortified products. Yet further, certain vitamins/supplements may be provided in a form that has an undesired taste (i.e., a fishy taste from certain forms of DHA that may cause “fish burps” in some consumers) and/or cause undesired side effects (i.e., nausea). For these reasons, many women have a difficult time maintaining daily usage compliance with the vitamins/supplements, and instead of choosing the fortified products, they opt instead for more tasty options that do not cause any undesired symptoms but that unfortunately provide empty calories with no health benefits. Therefore, there is a need in the art for new and improved nutrition systems that provide specialized, optimal levels of nutrients to women in each of the preconception, prenatal, pregnancy, postnatal, and/or lactating periods and that are designed for maximum optimal daily usage compliance therewith. It is to such systems, compositions used therein, and kits containing same, along with a range of products for use in the systems, as well as methods of making and using same, that the presently disclosed inventive concept(s) is directed.

### DETAILED DESCRIPTION

Before explaining at least one embodiment of the presently disclosed inventive concept(s) in detail, it is to be understood that the presently disclosed inventive concept(s) is not limited in its application to the details of construction and the arrangement of the components or steps or methodologies set forth in the following description or illustrated in the drawings. The presently disclosed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which this presently disclosed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed inventive concept(s) have been described in terms of preferred embodiments, it will be apparent to those of skill in the art that variations may be applied to the articles and/or methods and in the steps or in the sequence of steps of the method described herein without departing from the concept, spirit, and scope of the presently disclosed inventive concept(s). All such similar substitutes and modifications apparent to those skilled in the art are deemed to be within the spirit, scope, and concept of the presently disclosed inventive concept(s).

As utilized in accordance with the present disclosure, the following terms, unless otherwise indicated, shall be understood to have the following meanings:

The use of the word “a” or “an” when used in conjunction with the term “comprising” in the claims and/ or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternatives are mutually exclusive, although the disclosure supports a definition that refers to only alternatives and “and/or.”

Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent.

The use of the term “at least one” will be understood to include one as well as any quantity more than one, including but not limited to, 2, 3, 4, 5, 10, 15, 20, 30, 40, 50, 100, etc.

The term “at least one” may extend up to 100 or 1,000 or more, depending on the term to which it is attached; in addition, the quantities of 100/1,000 are not to be considered limiting, as higher limits may also produce satisfactory results.

In addition, the use of the term “at least one of X, Y, and Z” will be understood to include X alone, Y alone, and Z alone, as well as any combination of X, Y, and Z.

The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as ^{“}contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

The terms “baby” and “infant” are used interchangeably herein and will be understood to include, but are not limited to, newborns, neonates, premature babies/infants (also referred to as preterm babies/infants or preemies), and low-birth-weight babies/infants.

The term “mother” and “women” are used interchangeably herein and will be understood as a female in the stages of: preconception, prenatal, pregnancy, postnatal, and/or lactation.

The term “shelf-stable” as used herein refers to the ability of a food product to be safely stored and sold in a sealed container at room temperature while still having a useful shelf life in which the taste and nutritional aspects (i.e., nutritional integrity, nutritional potency, etc.), and microbial safety of the product is retained. Examples of periods considered to be a “useful shelf life” include, but are not limited to, at least about two months, at least about three months, at least about four months, at least about five months, at least about six months, and longer.

The term “Daily Value,” also referred to herein by the acronym DV, was established by the U.S. Food and Drug Administration (USFDA) for food and dietary labeling and refers to a reference point to assist people by providing a perspective of what their overall daily dietary need is, and indicates the percent of the recommended daily amount of each nutrient that a food serving or supplement dose provides. The Daily Values provided herein below are specific for pregnant and lactating women and are provided from the USFDA, Center for Food Safety and Applied Nutrition, A Food Labeling Guide (Appendix G: Daily Values for Infants, Children Less Than 4 Years of Age, and Pregnant and Lactating Women; January 2013). The DV replaces the previous designation of the U.S. Recommended Dietary Allowances (RDAs).

The DVs are made up of two sets of references, DRVs (Daily Reference Values) and RDIs (Reference Daily Intake). The DRVs are a set of dietary references that apply to fat, saturated fat, cholesterol, carbohydrate, protein, fiber, sodium and potassium. The RDIs are a set of dietary references based on the Recommended Dietary Allowances (RDAs) for essential vitamins and minerals and, in selected groups, protein. The RDAs, as further defined herein below, are a set of nutrient allowances established by the National Academy of Sciences. The RDAs are a part of the DRIs.

The term “Dietary Reference Intake,” also referred to herein by the acronym DRI, refers to a system of nutrition recommendations from the Institute of Medicine (TOM) of the U.S. National Academy of Sciences. The DRI system was introduced in 1997 to broaden the RDA guidelines. While the DRI values are not currently used in nutrition labeling, the older Reference Daily Intake (RDI) system is still in use. There are four types of DRI reference values, namely, the Estimated Average Requirement (EAR), the Recommended Dietary Allowance (RDA), the Adequate Intake (AI), and the Tolerable Upper Intake Level (UL). The primary goal of having these new dietary reference values was to not only prevent nutrient deficiencies but also to lower the risk of chronic diseases such as osteoporosis, cancer, and cardiovascular diseases.

The term “Estimated Average Requirement,” also referred to herein by the acronym EAR, refers to a daily nutrient intake value that is estimated to meet the requirement of half of the healthy individuals in a life stage and gender group. EAR is used to assess dietary adequacy and as a basis for the RDA.

The term “Recommended Dietary Allowance,” also referred to herein by the acronym RDA, refers to the average daily dietary intake level that is sufficient to meet the nutrient requirement of nearly all (97 to 98%) healthy individuals in a particular life-stage and gender group. An RDA for a given nutrient may vary depending on a person's age, sex, and physical condition (e.g., pregnancy).

The term “Adequate Intake,” also referred to herein by the acronym AI, refers to the recommended average daily nutrient intake level based on observed or experimentally determined approximations or estimates of nutrient intake by a group (or groups) of apparently healthy people who are assumed to be maintaining an adequate nutritional state.

The term “Tolerable Upper Intake Level,” also referred to herein by the acronym UL, refers to the highest average daily nutrient intake level likely to pose no risk of adverse health effects to almost all individuals in a given life-stage and gender group. The UL is not a recommended level of intake.

The term “Estimated Energy Requirement,” also referred to herein by the acronym EER, refers to the average dietary energy intake that is predicted to maintain energy balance in healthy, normal weight individuals if a defined age, gender, weight, height, and level of physical activity consistent with good health. In pregnant and lactating women, the EER includes the needs associated with growth or secretion of milk rates consistent with good health. Relative body weight (i.e., loss, stable, gain) is the preferred indicator of energy adequacy.

The term “Generally Recognized As Safe,” also referred to herein by the acronym GRAS, is a US Food and Drug Administration (FDA) designation that a chemical or substance added to food has adequately been shown to be safe under the conditions of its intended use. Such food additives that are considered safe by experts are thus exempted from the usual Federal Food, Drug, and Cosmetic Act (FFDCA) food additive tolerance requirements. The determination that a food substance is “GRAS” may either be made through scientific procedures or, for a substance used in food before 1958, through experience based on common use in food (which requires a substantial history of consumption for food use by a significant number of consumers).

The term “Good Manufacturing Practice,” also referred to herein by the acronym GMP, is a US FDA designation that a chemical or substance added to food is produced in accordance with good manufacturing practices, is provided in a quantity sufficient for a specific purpose, and/or is provided in a quantity not greater than that required. For example, but not by way of limitation, a use level of an ingredient is limited by good manufacturing practice (GMP) to the minimum amount required to produce an intended effect.

The term “complete meal” as used herein refers to a meal that is designed to provide one nutritionally-balanced serving; that is, it is not necessarily to combine the complete meal with another food product to provide a meal.

The term “incomplete meal” thus refers to a meal not satisfying the requirements of a complete meal, but forming a portion thereof; that is, a complete meal is formed upon combining two or more incomplete meals.

The terms “meal replacement” and “meal substitute” are used herein interchangeably and will be understood to refer to a composition that is intended as a substitute for a solid food meal and that contains a controlled quantity of calories and/or nutrients so as to provide a desired complete nutrition profile upon consumption.

The term “gap” as used herein refers to nutritional shortfalls, nutritional excesses, nutritional gaps, and/or nutrimental inadequacies during the preconception, prenatal, pregnancy, postnatal, lactation periods.

The presently disclosed inventive concept(s) possesses many benefits over the prior art. Turning now to the presently disclosed inventive concept(s), optimal nutrition systems for women during the preconception, prenatal, pregnancy, postnatal, and/or lactating periods are provided, along with compositions and kits for use therein and methods of making and using same.

Additionally, the presently disclosed inventive concept(s) helps to support a baby through its first 1,000 days (i.e., from conception through the first two years of age and/or up to 12 months thereafter) by delivering optimal nutrition from conception through lactation.

In an embodiment, the nutrition system is designed specifically to contain the right nutrients as well as the right dosage levels thereof.

In an embodiment, the nutrition system designed to identify the women's nutrient shortfalls, nutrient gaps, and/or nutrient inadequacy during childbearing age, and the preconception, prenatal, pregnancy, postnatal, and/or lactation periods.

In an embodiment, as described further in detail herein below, the design provides a personalized solution based on stage of preconception, prenatal, pregnancy, postnatal, and/or lactation.

In another embodiment, a personalized solution is based on the age of the mother.

In another embodiment, a personalized solution is based on the Body Mass Index (BMI) of the mother.

In another embodiment, a personalized solution is based on the body size of the mother.

In another embodiment, a personalized solution is based on the body composition of the mother.

In another embodiment, a personalized solution is based on the food limitations of the mother.

In another embodiment, a personalized solution is based on the food preference of the mother.

In another embodiment, a personalized solution is based on the physical activity level of the mother.

In yet another embodiment, a personalized solution is based on one or more characteristics of the mother; such as, but not limited to, age, Body Mass Index (BMI), weight, body size, body composition, food limitations, food preference and/or physical activity level.

In another embodiment, a personalized solution is based on one or more health conditions from which the mother suffers prior to pregnancy.

In an embodiment, a personalized solution is based on common health issue(s) from which the mother suffers during preconception, prenatal, pregnancy, postnatal, and/or lactation period.

In an embodiment, a personalized solution is based on common health issue(s) from which the mother suffers during pregnancy period.

In another embodiment, a personalized solution is based on common health issue(s) from which the mother suffers during lactation period.

In an embodiment, a personalized solution is based on common health issue(s) from which the mother suffers during post-pregnancy period.

In another embodiment, a personalized solution is based on common health issue(s) from which the mother suffers during, pre-pregnancy, pregnancy, post-pregnancy, and/or lactation period.

In an embodiment, a personalized solution based on one or more health conditions caused by and/or suffered during the pre-pregnancy period.

In an embodiment, a personalized solution based on one or more health conditions caused by and/or suffered during the pregnancy period.

In an embodiment, a personalized solution based on one or more health conditions caused by and/or suffered during the post-pregnancy period.

In an embodiment, a personalized solution based on one or more health conditions caused by and/or suffered during the lactating period.

In an embodiment, a personalized solution based on one or more health conditions caused by and/or suffered during the pre-pregnancy, pregnancy, post-pregnancy, and/or lactating period.

In another embodiment, a personalized solution is based but not limited to, the previous described combinations.

In one embodiment, the nutrition system is designed and customized specifically to address the nutrient gaps and/or nutrient inadequacies experienced by a sizeable group of preconception, prenatal, pregnant, postnatal, and/or lactating women to support a healthy pregnancy as well as healthy development of a fetus and an infant during the first two years of life and/or up to 12 months thereafter.

In an embodiment, the nutrition system is designed and pre-approved for use during preconception, prenatal, pregnancy, postnatal, and/or lactation weight loss, so the nutrition system provides a convenient way for preconception, prenatal, pregnant, postnatal, and/or lactating women to address her nutrient gaps and/or nutrient inadequacies without requiring her to perform extensive time-consuming research and calculations.

In an embodiment, the nutrition system possesses better tolerability than prior art supplements alone, which many pregnant women struggle to keep down, especially in the first trimester of pregnancy. In addition, better absorption of nutrients found in food consumed throughout the day is observed, as opposed to the absorption of nutrients observed via administration of a single supplement that is taken once per day.

In an embodiment, the nutrition system is designed to complement a prenatal vitamin with nutrients that are not provided 100%, to ensure that preconception, prenatal, pregnant, postnatal, and/or lactating women receive the full nutrition that she needs.

In an embodiment, the nutrition system is designed to replace a prenatal vitamin with nutrients that are provided at 100%, to ensure that preconception, prenatal, pregnant, postnatal, and/or lactating women receive the full nutrition that she needs.

In an embodiment, the nutrition system is designed to ensure maximum optimum daily use compliance.

In an embodiment, the nutrition system is designed to ensure the safe use of the nutrients that are provided at 100%.

In an embodiment, condition-specific nutrients are designed and/or customized specifically to address the nutrient inadequacies experienced by a sizeable group of preconception, prenatal, pregnant, postnatal, and/or lactating women to support a healthy pregnancy as well as healthy development of a fetus and an infant during the first two years of life and/or up to 12 months thereafter.

In one embodiment, the nutrient system is designed and customized to fulfill the needs of the women during the preconception.

In one embodiment, the nutrition system prepares the women for an easier childbirth.

In an embodiment, the nutrition system helps women during fertility procedure(s).

In another embodiment, wherein the nutrition system helps women, not limited to, women going through In Vitro Fertilization (IVF), other fertility procedures, and/or fertility treatments.

In an embodiment, the nutrition system helps women with further pregnancies.

In another embodiment, wherein for example, but not by way of limitation, the nutrition system helps healing the uterus after a Cesarean-section to increase the odds of a Vaginal Birth After Cesarean (V-BAC), and/or minimizing the risk of osteoporosis.

In one embodiment, the nutrition system benefits the women during the lactation stage.

In another embodiment, the nutrition system (for example, but not by way of limitation) benefits the mother's milk quality and mother's milk quantity.

Additionally, the presently disclosed inventive concept(s) enables mitigation of common pregnancy symptoms. For example, but not by way of limitation, constipation and/or bloating are addressed through the presence of fiber, and fatigue is addressed through the presence of protein and the usage of a snackable format.

In one embodiment, nausea is addressed through the usage of specific delivery format and/or specific nutrients.

In an embodiment, nausea is addressed through the occasions of delivery of the nutrition system. For example, but not by way of limitation, a morning bundle of nutrients may be different to the night bundle of nutrients. The delivery of the nutrition system as part of breakfast and/or small snacks consumed throughout the day (day-part eating) can deter the onset of nausea.

In one embodiment, the nutrition system is designed to possess a delicious taste that is superior to other fortified products currently on the market, which suffer from a bland taste.

In an embodiment, the nutrition system is designed to minimize off-note aromas.

In another embodiment, wherein the taste profile of the nutrition system is optimized by, but not limited to, customizing the vitamin blend for each product based on the natural presence of each nutrient in the recipes.

In an embodiment, the nutrition system is optimized so as not to aggravate the various pregnancy symptoms.

In another embodiment, the nutrition system is optimized to potentially mitigate the various symptoms of pregnancy.

In an embodiment, the nutrition system is personalized and customized to the individual; addressing the cravings and/or root cause of nutrition deficiencies during the pregnancy or/and lactation period.

In another embodiment, the nutrition system curbs cravings, for example, but not limited to, educating the women and/or by providing the women with condition-specific nutrients that minimizes and/or alleviates certain conditions/issues.

In another embodiment, the nutrition system curbs the root cause of nutrition deficiency, for example, but not limited to, educating the women and/or providing the women with condition-specific nutrients that minimizes and/or alleviates certain conditions/issues.

In another embodiment, the nutrition system improves the baby's nutrition by providing better nutrition from mom's consumption this is passed to baby for example, but not limited to, the umbilical cord, or the breast milk.

In an embodiment, the nutrition system includes herbs and/or herbs extracts.

In another embodiment, the herbs and/or herbs extracts are selected from the group: ginger, fenugreek, chamomile, mint, or combination thereof.

Additionally, in one embodiment, the nutrient system provides an alternative to empty calorie snacking occasions, the presently disclosed inventive concept(s) results in consumption of nutrient-rich snacks and/or meals that benefit the women, mother, baby, and/or the overall pregnancy.

In an embodiment, the nutrition profile of the presently disclosed inventive concept(s) supports good metabolic health and helps a pregnant mother from gaining excess weight or consuming excess solid fats or added sugars which could lead to in appropriate weight and risks associated with that such as gestational diabetes.

In another embodiment, the nutrition system keeps the individual's blood sugar levels stable. Further, the nutrition system maintains the person's good mood by keeping the blood sugar levels stable.

Additionally, in an embodiment, the nutrient system uses in whole or in part non-Genetically Modified Organisms (non-GMO).

In an embodiment, another advantage of the presently disclosed inventive concept(s) is that the presence of particular nutrients in the nutrition system can be varied depending on the stage of pregnancy/lactation and/or other factors, as appropriate. Likewise, the dosage levels of particular nutrients in the nutrition system can be varied, depending on the stage of pregnancy/lactation and/or other factors, as appropriate. That is, the presence and/or dosage levels of particular nutrients can vary between the preconception period; the first, second, and/or third trimesters of pregnancy; and the periods of lactation and/or postnatal weight loss.

In another embodiment, the presence of particular nutrients in the nutrition system can be varied depending one or more characteristics of a mother (such as, but not limited to, age, weight, body size, body composition, and/or level of physical activity) while still ensuring that the mother is receiving balanced nutrition in addition to a proper amount of weight gain/loss (i.e., assisting an undernourished mother in gaining the proper amount of weight during pregnancy, minimizing the weight gain of an overweight pregnant mother, and/or assisting with postnatal weight loss of a lactating mother.

In another embodiment, the presence and/or dosage levels of particular nutrients are varied in response, but not limited, to one or more of the following:
(i) poor maternal dietary intake of nutrients (which may occur during any of the preconception, prenatal, pregnancy, postnatal, and/or lactation periods);
(ii) inadequate dietary patterns (i.e. low consumption of fruits, vegetable, whole grains, low-fat dairy, lean meat; and high consumption of foods with excess calories, saturated fat, added sugars, sodium, and minimal nutritional value)
(iii) one or more health conditions from which the mother suffers prior to pregnancy (i.e., obesity, diabetes, etc., and including genetically and/or environmentally related conditions);
(iv) the increased and varying nutritional needs caused by the actual pregnancy/lactation;
(v) common health issue(s) suffered during pregnancy/lactation (i.e., nausea, vomiting, fatigue, sleeplessness, constipation, bloating, diarrhea, etc.); and/or
(vi) one or more health conditions caused by and/or suffered during the pregnancy/lactation period (i.e., gestational diabetes, anemia, pregnancy-induced hypertension, etc., and including genetically and/or environmentally related conditions).

In an embodiment, the nutrition system can provide a personalized, customized diet containing stage- and/or condition-specific nutrients that minimize and/or alleviate certain conditions/issues. For example, but not by way of limitation, cravings, nutrition deficiencies, or/and combination thereof.

In one embodiment, the nutrition system is personalized and customized to the individual; addressing the cravings and/or root cause of nutrition deficiencies during the pregnancy or/and lactation period.

In an embodiment, the nutrition system curbs cravings, for example, but not limited to, educating the women and/or by providing the women with condition-specific nutrients that minimizes and/or alleviates certain conditions/issues.

In an embodiment, the nutrition system curbs the root cause of nutrition deficiency, for example, but not limited to, educating the women and/or providing the women with condition-specific nutrients that minimizes and/or alleviates certain conditions/issues.

In another embodiment, the nutrition system helps to assure adequate intakes of key nutrients to support a healthy pregnancy and lactation.

In one embodiment, the nutrition system is designed to enable nutrition to pass through the placenta of a pregnant mother, thereby allowing her fetus to achieve the appropriate birth weight and nutritional status.

In an embodiment, the nutrition system is designed for use by a lactating mother to pass on important nutrients for development of the baby through breast milk (such as, but not limited to, DHA), thereby allowing her infant to achieve the appropriate growth rate and nutritional status.

In another embodiment, the nutrition system benefits the women during the lactation stage.

In another embodiment (for example, but not by way of limitation), the nutrition system benefits the mother's milk quality and mother's milk quantity.

In one embodiment, the nutrition system blends different forms of a nutrient together to aid with digestibility and/or time release as well as to provide for taste management and thereby minimize taste negatives, undesired side effects, and pregnancy discomforts.

In an embodiment, the additional features of delayed-release and/or time-release nutrition are that different nutrients can be absorbed in different parts of the gastrointestinal system and/or aid with various issues/conditions (i.e., sleeplessness, nausea, vomiting, constipation, bloating, diarrhea, and the like).

In an embodiment, the nutrition system includes probiotics which are optimized for preconception, prenatal, pregnant, postnatal, and/or lactating women.

In an embodiment, the nutrition system includes prebiotics which are optimized for preconception, prenatal, pregnant, postnatal, and/or lactating women.

In another embodiment, the nutrition system is designed to include prebiotics and/or probiotics which are optimized for preconception, prenatal, pregnant, postnatal, and/or lactating women.

In yet another embodiment, wherein, for example, but not by way of limitation, pregnancy optimized prebiotics and/or probiotics reduce nausea in the upper gastrointestinal and reduce gas in the lower gastrointestinal and/or provide an increased gastrointestinal tolerance and/or to treat or prevent problems with the gastrointestinal tract.

In an embodiment, in addition to the advantageous properties of the presently disclosed inventive concept(s) mentioned herein above, certain embodiments of the nutrition system disclosed herein possess skin health benefits.

In another embodiment, many pregnant women complain of various skin problems, including but not limited to, acne, rashes, itchy skin, skin darkening (including dark blotches on the face (often referred to as the “pregnancy mask”), darkening of the linea nigra, and darkening of existing features such as freckles, moles, birthmarks, and brown spots), stretch marks, varicose veins, skin tags, brittle or splitting nails, as well as worsening of existing skin conditions.

In yet another embodiment, while there are topical pharmaceutical compositions and/or oral pharmaceutical compositions that minimize or alleviate one or more of these conditions, many of these pharmaceutical compositions are not advised for use during pregnancy.

In yet another embodiment, many others have not been tested for effects on pregnancy/lactation, and thus pregnant/lactating women typically choose not to use them for fear of harming the fetus/infant. Thus, pregnant/lactating women are limited in the substances that they can use to treat the specific skin problems of pregnancy. In contrast, the presently disclosed inventive concept(s) contains nutritional substances that also provide preconception, prenatal, pregnancy, and/or postnatal skin health benefits (such as, but not limited to, vitamin D). Thus, the nutrition systems disclosed or otherwise contemplated herein function to nourish and hydrate the skin from within, and also function to minimize and/or alleviate certain skin problems of pregnancy.

In an embodiment of the presently disclosed inventive concept(s) is directed to a composition used in accordance with the nutritional kits, nutritional systems, and methods described herein.

In an embodiment, the composition comprises at least one food and/or beverage product that includes a preconception, prenatal, pregnancy, postnatal, and/or lactation fundamental nutrient bundle as defined herein below.

In another embodiment, the preconception, prenatal, pregnancy, postnatal, and/or lactation fundamental nutrient bundle includes at least three preconception/prenatal/postnatal fundamental micronutrients, and further include the macronutrient fiber.

In yet another embodiment, at least one food and/or beverage product is shelf-stable.

In yet another embodiment, at least one food and/or beverage product is a perishable product; such as, but not limited to, a product that must be refrigerated and/or frozen.

In an embodiment, the nutrients used in whole or in part in the composition are non-Genetically Modified Organisms (non-GMO).

In an embodiment, the bundle of nutrients used in whole or in part in the composition is non-Genetically Modified Organisms (non-GMO).

In an embodiment, nutrient forms used in whole or in part in the composition are selected based upon optimal nutritional bioavailability.

In an embodiment, the composition also includes at least one macronutrient of protein, amino acids, carbohydrate, or combinations thereof.

In another embodiment, the composition is further defined as having an optimal metabolic health profile that includes one or more of: less than or equal to 20% calories from added sugar; less than 3 g fat; 0 g trans-fat; less than 60 mg cholesterol; and less than 300 mg sodium.

In another embodiment, the composition has a pleasing taste that is acceptable to preconception, prenatal, and/or postnatal women; and is designed specifically for consumption during one or more periods spanning from preconception through postnatal lactation.

In an embodiment, the composition is designed to possess a delicious taste that is superior to other fortified products currently on the market, which suffer from a bland taste.

In an embodiment, the composition is designed to minimize off-note aromas.

In another embodiment, wherein the pleasing taste is achieved; but not limited to, by minimizing the salty and/or metallic taste caused by potassium and/or magnesium.

In yet another embodiment, the taste profile is optimized by, but not limited to, customizing the vitamin blend for each product based on the natural presence of each nutrient in the recipes.

In an embodiment, the composition is optimized so as not to aggravate the various pregnancy symptoms.

In another embodiment, the composition is optimized to potentially mitigate the various symptoms of pregnancy.

In an embodiment, the composition is sized and/or proportioned to serve as a complete meal or meal replacement, as an incomplete meal component (that is combined with other incomplete meal component(s) to form a complete meal), and/or as a snack.

In another embodiment, the composition contains real, whole ingredients that are as minimally processed as possible and thus provide needed calories to the women, as opposed to the empty calories of many meal/snack products currently available.

In an embodiment, the composition is a vegetable-based food/beverage product and/or a fruit-based food/beverage product.

In an embodiment, the composition is a dairy-based food/beverage product. In an embodiment, the composition is a milk-based food/beverage product.

In another embodiment, the composition is in the form of a single food/beverage item (i.e., a bar, a square, product delivered in a pouch, product delivered in a jar, product delivered in a sachet, product delivered in a cup, product delivered in a cryopack, etc.),

In yet another embodiment, the composition includes a single serving of a form of food/beverage that comprises multiple items (i.e., a cereal, an oatmeal, a granola, or other cluster-type product, etc.).

In an embodiment, the composition may include (but not by way of limitation) the carotenoid nutrient lutein helping lactating and/or breastfeeding mothers; but not in the composition when helping women during pregnancy.

In an embodiment, the composition may include (but not by way of limitation) the carotenoid nutrients lutein and/or zeaxanthin helping women during pregnancy. In an embodiment, the composition includes (but is not limited to) the carotenoid nutrients lutein and/or zeaxanthin helping women during pregnancy and lactation.

In an embodiment, the composition may include (but not by way of limitation) the carotenoid nutrients lutein and/or zeaxanthin helping lactating and/or breastfeeding mothers; but not in the composition when helping women during pregnancy.

In another embodiment, the composition may include (but not by way of limitation) the carotenoid nutrients lutein helping lactating and/or breastfeeding mothers; but not in the composition when helping women during pregnancy.

In yet another embodiment, the composition may include (but not by way of limitation) the carotenoid nutrient lutein helping women during pregnancy; but not in the composition when helping lactating and/or breastfeeding mothers.

In an embodiment, the composition may include (but not by way of limitation) probiotics that are optimized for preconception, prenatal, pregnant, postnatal, and/or lactating women.

In another embodiment, the composition may include (but not by way of limitation) prebiotics that are optimized for preconception, prenatal, pregnant, postnatal, and/or lactating women.

In yet another embodiment, the composition may include (but not by way of limitation) a combination of prebiotics and probiotics that are optimized for preconception, prenatal, pregnant, postnatal, and/or lactating women.

In a further embodiment, non-limiting examples are pregnancy optimized prebiotics and/or probiotics that reduce nausea in the upper gastrointestinal and reduce gas in the lower gastrointestinal and/or provide an increased gastrointestinal tolerance and/or to treat or prevent problems with the gastrointestinal tract.

In an embodiment, preconception, prenatal, pregnancy, postnatal, and/or lactation nutrient bundles include any combination of at least three preconception, prenatal, pregnancy, postnatal, and/or lactation fundamental micronutrients (and/or fibers) that allow the composition to function in accordance with the presently disclosed inventive concept(s).

In another embodiment, non-limiting examples of fundamental nutrients that are included within the bundles include docosahexaenoic acid (DHA), choline, folic acid, calcium, vitamin C, vitamin D, vitamin E, magnesium, potassium, lutein, zeaxanthin, iodine, iron, fiber, vitamin K, progesterone, dehydroepiandrosterone (DHEA), Coenzyme Q₁₀ (CoQ₁₀), zinc, selenium, inositol, L-arginine, N-acetyl, cysteine analogs and derivatives thereof, as well as various combinations thereof, and the like.

Examples of fundamental preconception, prenatal, pregnancy, postnatal, and/or lactation nutrient bundles that are utilized in accordance with the presently disclosed inventive concept(s) include, but are not limited to:
(a) 2 preconception, prenatal, pregnancy, postnatal, and/or lactation fundamental nutrients comprising DHA and Choline or DHA and Folic acid or Choline and Folic Acid;
(b) 3 preconception, prenatal, pregnancy, postnatal, and/or lactation fundamental micronutrients comprising DHA, choline, and folic acid;
(c) 4 preconception, prenatal, pregnancy, postnatal, and/or lactation fundamental micronutrients comprising DHA, choline, folic acid, and calcium;
(d) 5 preconception, prenatal, pregnancy, postnatal, and/or lactation fundamental micronutrients comprising DHA, folic acid, calcium, vitamin D, and magnesium;
(e) 5 preconception, prenatal, pregnancy, postnatal, and/or lactation fundamental micronutrients comprising DHA, choline, folic acid, calcium, and vitamin D;
(f) 6 preconception, prenatal, pregnancy, postnatal, and/or lactation fundamental micronutrients comprising DHA, folic acid, calcium, vitamin D, magnesium, and potassium;
(g) 6 preconception, prenatal, pregnancy, postnatal, and/or lactation fundamental micronutrients comprising DHA, choline, folic acid, calcium, vitamin D, and magnesium;
(h) 7 preconception, prenatal, pregnancy, postnatal, and/ or lactation fundamental micronutrients comprising DHA, choline, folic acid, calcium, vitamin D, magnesium, and potassium;
(i) 7 preconception, prenatal, pregnancy, postnatal, and/ or lactation fundamental nutrients comprising DHA, folic acid, calcium, vitamin D, magnesium, potassium, and fiber;
(j) 8 preconception, prenatal, pregnancy, postnatal, and/or lactation fundamental nutrients comprising DHA, choline, folic acid, calcium, vitamin D, magnesium, potassium, and fiber and
(k) 8 preconception, prenatal, pregnancy, postnatal, and/or lactation fundamental nutrients comprising DHA, choline, folic acid, calcium, vitamin D, Vitamin C, Vitamin E, and fiber.

In an embodiment, each preconception, prenatal, pregnancy, postnatal, and/or lactation fundamental micronutrient is included in the preconception, prenatal, pregnancy, postnatal, and/or lactation nutrient bundle and provides one or more benefits to the fetus/infant and/or the mother.

In another embodiment, for example, but not by way of limitation: folic acid reduces pregnant women's risk of having a child with a brain or spinal cord birth defect; choline and/or DHA help support baby's brain development; and calcium, magnesium, and/or vitamin D are a critical trio that supports healthy bones during pregnancy (a time when a growing baby can tap into mom's own reserves). In addition, potassium is critical for maintaining fluid and electrolyte balance in the body's cells, especially during pregnancy, when blood volume expands by up to 50%. Also, lutein protects eyes by absorbing potentially damaging light and protects against oxidative damage. Further, vitamin E reduces the risks of complications in late pregnancy due to high blood pressure (preeclampsia), premenstrual syndrome (PMS), painful periods, menopausal syndrome, hot flashes associated with breast cancer, and breast cysts. Also, vitamin C assists with iron absorption. The DHEA hormone is known to help revitalize the ovarian environment in which eggs mature. Coenzyme Q₁₀ (CoQ₁₀) provides a fertility benefit for women with low ovarian reserves. In addition, the body absorbs iron more efficiently during pregnancy. Therefore, the presence of iron in the preconception, prenatal, pregnancy, postnatal, and/or lactation nutrient bundle assists with the consumption of more iron to ensure that mother and baby are receiving enough oxygen. Yet further, iron will also minimize or alleviate symptoms such as tiredness, weakness, irritability, and depression.

In another embodiment, enhancers are added to the nutrient system that benefits the fetus and/or infant, wherein enhancers for example, but not by way of limitation, calcium prevents heartburn, Vitamin B6 prevents nausea, prune juice and/or hydration and/or beverages softens the stool for constipation relief, cinnamon helps to control the glucose levels.

In a further embodiment, enhancers can be added to the nutrient system that benefit preconception, prenatal, pregnant, postnatal, and/or lactating women; wherein enhancers for example, but not by way of limitation, calcium prevents heartburn, Vitamin B12 prevents nausea, prune juice and/or hydration and/or beverages softens the stool for constipation relief; cinnamon helps the control to glucose levels, guaifenesin softens the cervix for the labor preparation.

In an embodiment, each nutrient of the preconception, prenatal, pregnancy, postnatal, and/ or lactation nutrient bundle is present in the composition at a desired level (i.e., percent of daily value (DV) therefor) that ensures responsible fortification; however, the level is low enough to minimize the risk of exceeding a tolerable upper limit for daily intake. For example, but not by way of limitation, a nutrient is present in the composition at a level of about 0.1% DV, about 0.2% DV, about 0.3% DV, about 0.4% DV, about 0.5% DV, about 0.6% DV, about 0.7% DV, about 0.8% DV, about 0.9% DV, about 1% DV, about 2% DV, about 3% DV, about 4% DV, about 5% DV, about 6% DV, about 7% DV, about 8% DV, about 9% DV, about 10% DV, about 11% DV, about 12% DV, about 13% DV, about 14% DV, about 15% DV, about 16% DV, about 17% DV, about 18% DV, about 19% DV, about 20% DV, about 21% DV, about 22% DV, about 23% DV, about 24% DV, about 25% DV, about 26% DV, about 27% DV, about 28% DV, about 29% DV, about 30% DV, about 31% DV, about 32% DV, about 33% DV, about 34% DV, about 35% DV, about 36% DV, about 37% DV, about 38% DV, about 39% DV, about 40% DV, about 41% DV, about 42% DV, about 43% DV, about 44% DV, about 45% DV, about 46% DV, about 47% DV, about 48% DV, about 49% DV, about 50% DV, about 51% DV, about 52% DV, about 53% DV, about 54% DV, about 55% DV, about 56% DV, about 57% DV, about 58% DV, about 59% DV, about 60% DV, about 61% DV, about 62% DV, about 63% DV, about 64% DV, about 65% DV, about 66% DV, about 67% DV, about 68% DV, about 69% DV, about 70% DV, about 71% DV, about 72% DV, about 73% DV, about 74% DV, about 75% DV, about 76% DV, about 77% DV, about 78% DV, about 79% DV, about 80% DV, about 81% DV, about 82% DV, about 83% DV, about 84% DV, about 85% DV, about 86% DV, about 87% DV, about 88% DV, about 89% DV, about 90% DV, about 91% DV, about 92% DV, about 93% DV, about 94% DV, about 95% DV, about 96% DV, about 97% DV, about 98% DV, about 99% DV, about 100% DV, about 150% DV, about 200% DV, about 250% DV, about 300% DV, about 350% DV, about 400% DV, about 450% DV, about 500% DV, about 550% DV, about 600% DV, about 650% DV, about 700% DV, about 750% DV, about 800% DV, about 850% DV, about 900% DV, about 950% DV, about 1,000% DV, and the like. In other non-limiting examples, a nutrient is present in the composition at a level in a range between any two values listed above (such as, but not limited to, a range of from about 0.1% DV to about 100% DV; a range of from about 1% DV to about 50% DV; a range of from about 1% DV to about 10% DV; a range of from about 5% DV to about 25% DV; and the like). Particular, non-limiting examples of value(s) ranges at which each nutrient of the preconception, prenatal, pregnancy, postnatal, and/or lactation nutrient bundle is supplied are shown in Table 1.

In another embodiment, the macronutrient(s) (i.e., protein, amino acids, fiber, and/or carbohydrate) can be present in the composition at a desired level (i.e., percent of daily value (DV) therefor) that ensures responsible fortification; however, the level is low enough to minimize the risk of exceeding a tolerable upper limit for daily intake. For example, but not by way of limitation, each macronutrient is present in the composition at a level of about 0.1% DV, about 0.2% DV, about 0.3% DV, about 0.4% DV, about 0.5% DV, about 0.6% DV, about 0.7% DV, about 0.8% DV, about 0.9% DV, about 1% DV, about 2% DV, about 3% DV, about 4% DV, about 5% DV, about 6% DV, about 7% DV, about 8% DV, about 9% DV, about 10% DV, about 11% DV, about 12% DV, about 13% DV, about 14% DV, about 15% DV, about 16% DV, about 17% DV, about 18% DV, about 19% DV, about 20% DV, about 21% DV, about 22% DV, about 23% DV, about 24% DV, about 25% DV, about 26% DV, about 27% DV, about 28% DV, about 29% DV, about 30% DV, about 31% DV, about 32% DV, about 33% DV, about 34% DV, about 35% DV, about 36% DV, about 37% DV, about 38% DV, about 39% DV, about 40% DV, about 41% DV, about 42% DV, about 43% DV, about 44% DV, about 45% DV, about 46% DV, about 47% DV, about 48% DV, about 49% DV, about 50% DV, about 51% DV, about 52% DV, about 53% DV, about 54% DV, about 55% DV, about 56% DV, about 57% DV, about 58% DV, about 59% DV, about 60% DV, about 61% DV, about 62% DV, about 63% DV, about 64% DV, about 65% DV, about 66% DV, about 67% DV, about 68% DV, about 69% DV, about 70% DV, about 71% DV, about 72% DV, about 73% DV, about 74% DV, about 75% DV, about 76% DV, about 77% DV, about 78% DV, about 79% DV, about 80% DV, about 81% DV, about 82% DV, about 83% DV, about 84% DV, about 85% DV, about 86% DV, about 87% DV, about 88% DV, about 89% DV, about 90% DV, about 91% DV, about 92% DV, about 93% DV, about 94% DV, about 95% DV, about 96% DV, about 97% DV, about 98% DV, about 99% DV, about 100% DV, about 150% DV, about 200% DV, about 250% DV, about 300% DV, about 350% DV, about 400% DV, about 450% DV, about 500% DV, about 550% DV, about 600% DV, about 650% DV, about 700% DV, about 750% DV, about 800% DV, about 850% DV, about 900% DV, about 950% DV, about 1000% DV, and the like. In other non-limiting examples, a macronutrient is present in the composition at a level in a range between any two values listed above (such as, but not limited to, a range of from about 0.1% DV to about 100% DV; a range of from about 1% DV to about 50% DV; a range of from about 1% DV to about 10% DV; a range of from about 5% DV to about 25% DV; and the like). Particular, non-limiting examples of value(s) ranges at which each macronutrient is supplied are shown in Table 1.

In an embodiment, the presence and/or dosage levels of the micronutrients and/or macronutrients in the composition can vary, depending on the stage of pregnancy and/or lactation and/or other factors, as appropriate. That is, the dosage levels of particular nutrients in the nutrition system can be varied, depending on the stage of pregnancy and/or lactation and/or other factors, as appropriate. That is, the presence and/or dosage levels of particular nutrients can vary between the preconception period; the first, second, and/or third trimesters of pregnancy; and the periods of lactation and/or postnatal weight loss.

In an embodiment, the presence of particular nutrients in the composition can be varied depending one or more characteristics of a mother (such as, but not limited to, age, weight, body size, body composition, and/or level of physical activity) while still ensuring that the mother is receiving balanced nutrition in addition to a proper amount of weight gain or weight loss (i.e., assisting an undernourished mother in gaining the proper amount of weight during pregnancy, minimizing the weight gain of an overweight pregnant mother, and/or assisting with postnatal weight loss of a lactating mother).

In another embodiment, the presence and/or dosage levels of particular nutrients may be varied in response to one or more of the following:
(i) poor maternal dietary intake of nutrients (which may occur during any of the preconception, prenatal, pregnancy, postnatal, and/or lactation periods);
(ii) inadequate or unhealthy dietary patterns (i.e. low consumption of fruits, vegetable, whole grains, low-fat dairy, lean meat; and high consumption of foods with excess calories, saturated fat, added sugars, sodium, and minimal nutritional value);
(iii) one or more pre-pregnancy existing health conditions (i.e., obesity, diabetes, etc., and including genetically and/or environmentally related conditions);
(iv) increased and or varying nutritional needs during pregnancy and/or lactation;
(v) common symptoms that may arise during pregnancy and/or lactation (i.e., nausea, vomiting, fatigue, sleeplessness, constipation, bloating, diarrhea, etc.); and/or
(vi) one or more pregnancy-induced health conditions (i.e., gestational diabetes, anemia, hypertension, etc., and including genetically and/or environmentally related conditions).

In one embodiment, nutrient forms used in whole or in part in the composition are selected based upon optimal nutritional bioavailability.

In an embodiment, each nutrient presented in the composition in any form allows the composition to function in accordance with the presently disclosed inventive concept(s). In particular, the forms of each nutrient are selected specifically to protect nutrient integrity and/or potency throughout shelf life of the composition formed therefrom and to ensure that delicious taste is preserved for the composition.

In another embodiment, the forms of each nutrient are also selected specifically to ensure a desired absorption level for the nutrient; the presence of the nutrients in a food/beverage composition provides better absorption than that observed from a supplement alone and thereby provides greater bioavailability of the nutrients. Specific, non-limiting examples of forms in which certain nutrients are disposed in the compositions of the presently disclosed inventive concept(s) are shown in Table 1.

Solely for the purposes of space, the term “about” was omitted in front of each number appearing in Table 1; however, it will be understood that slight variations can occur in the values/value ranges listed in Table 1. The scope of the presently disclosed inventive concept(s) encompasses not only the specific, finite values/value ranges listed in Table 1 (i.e., 7.1 g protein, 0-130 mg calcium, etc.) but also slight variations in each of the values/value ranges listed therein (i.e., about 7.1 g protein, a range from about 0 mg to about 130 mg calcium, etc.).

The presently disclosed inventive concept(s) is directed to a kit containing one or more of any of the compositions disclosed or otherwise contemplated herein.

In an embodiment, a kit includes one or more of the compositions, such as but not limited to, two or more of the compositions, three or more of the compositions, four or more of the compositions, five or more of the compositions, six or more of the compositions, seven or more of the compositions, eight or more of the compositions, nine or more of the compositions, ten or more of the compositions, eleven or more of the compositions, twelve or more of the compositions, thirteen or more of the compositions, fourteen or more of the compositions, fifteen or more of the compositions, sixteen or more of the compositions, seventeen or more of the compositions, eighteen or more of the compositions, nineteen or more of the compositions, twenty or more of the compositions, and the like.

In another embodiment, each composition present in the kit can be the same, or the kit can contain two or more different types of compositions. For example, but not by way of limitation, a kit can contain two or more compositions:
(1) a composition designed for consumption as part or all of a breakfast meal, and
(2) one or more compositions designed for consumption as part or all of a snack.

In an embodiment, the kit(s) are presented in gift form.

In an embodiment, the kit(s) are designed as a grazing box

In an embodiment, the kit(s) are delivered to the individual.

In another embodiment, the kit(s) are presented in gift form and/or are delivered to the individual.

In another embodiment, the kit(s) are designed as a grazing box and/or delivered to the individual.

In yet another embodiment, the kit(s) are designed as a grazing box, presented in gift form delivered to the individual.

In an embodiment, any of the kits described herein above or otherwise contemplated herein are used with any of the systems, methods, and assemblies described or otherwise contemplated herein below.

In one embodiment, the kits of the presently disclosed inventive concept(s) include one or more sets of instructions.

In an embodiment, the instructions explain how to use the kit and/or how to select additional foods, beverages, and/or supplements to use in combination with the kit.

In another embodiment, any type of format capable of conveying the desired information (and/or directing a user's attention to a location where said information can be found) is utilized as the instructions described or otherwise contemplated herein. Non-limiting examples of formats in which the instructions are provided include written wording and/or pictorial drawings, hardware, software, a website address, a bar code (such as but not limited to, a Quick Response (QR) or Universal Product Code (UPC)) that is readable by an imaging device/code reader, combinations thereof, and the like.

In another embodiment, the instructions are in a static form or in an interactive form.

In an embodiment, the instructions provided with the kits provide an analysis of the remaining desired daily intake level(s) of one or more of calories/energy, macronutrient(s), and/or one or more components of the preconception, prenatal, pregnancy, postnatal, and/or lactation nutrient bundle following consumption of the composition(s) contained in the kits.

In an embodiment, the instructions are be in the form of a consumption schedule.

In an embodiment, the instructions are in the form of a menu planner.

In an another embodiment, the consumption schedule and/or menu planner formats known in the art or otherwise contemplated herein utilized in accordance with the presently disclosed inventive concept(s).

In one embodiment, the instructions include one or more recommendations on other food options that are consumed in combination with the one or more compositions (as described or otherwise contemplated herein) to provide an optimal daily nutritional profile for the preconception, prenatal, pregnant, postnatal, and/or lactating women; and/or ensure good metabolic health therefor.

In an embodiment, the recommendation(s) also include an evaluation of optimal consumption time(s) and/or order(s) of consumption of the composition(s)/food(s) to provide better absorption of the macronutrients and/or micronutrients present in composition(s)/food(s) consumed throughout the day and thus ensure the greatest bioavailability of the macronutrients/micronutrients.

In another embodiment, recommendation(s) regarding consumption of particular composition(s) and/or food(s) at various times and/or day parts will provide for release delay and/or time release nutrition so that different macronutrients and/or micronutrients can be absorbed in different parts of the gastrointestinal tract, and thus can help alleviate certain prenatal/postnatal symptoms (i.e., nausea, vomiting, fatigue, sleeplessness, constipation, bloating, diarrhea, etc.). For example, but not by way of limitation, the effects of consuming a bundle of nutrients in the morning or at night may have an important role in the absorption and toleration of the body, during prenatal/postnatal stage. Therefore, the instructions include a recommended consumption schedule for the composition(s)/food(s).

In an embodiment, the recommended consumption schedule includes, but not limited:
(i) recommendation(s) on the order of consumption of the composition(s) and food(s),
(ii) recommendation(s) on the time(s) of consumption for one or more of the composition(s)/food(s) (which may be in the form of actual time(s)/day part(s) or relative values that are in relation to the other composition(s)/food(s) to be consumed), or
(iii) meal planning recommendation(s), wherein the composition(s)/food(s) are separated into complete meals, meal replacements, incomplete meal components that are combined to provide a complete meal, and/or snacks.

In an embodiment, when the instructions are provided in an interactive form, the instructions are further be defined as a device that calculates the values/recommendations discussed herein above based upon the various types of information related to the composition(s), the stage of preconception, prenatal, pregnancy, postnatal, and/or lactation, characteristic(s) of the mother, and/or conditions/issues of the women, mother, fetus, and/or infant (as described in detail herein above) input into the device. Any device capable of calculating one or more values/recommendations as described herein above based on the input of multiple variables are utilized in accordance with the presently disclosed inventive concept(s).

In another embodiment, non-limiting examples of devices that are utilized include simple, manually manipulated devices (such as, but not limited to, slide rule-type devices, nomogram-type devices, sliding window(s)-type devices, as well as any other type of chart and/or diagram that requires manual manipulation to determine a calculated value) as well as logic devices (such as, but not limited to, software and/or hardware-type devices, such as a microprocessor, microcontroller, application specific integrated circuit, field programmable gate array or the like).

In an embodiment, the kits of the presently disclosed inventive concept(s) include one or more preconception, prenatal, pregnancy, postnatal, and/or lactation supplements. Any prenatal and/or postnatal supplement known or otherwise contemplated in the art is utilized in combination with the compositions and as part of the kits of the presently disclosed and claimed inventive concept(s). Prenatal and/or postnatal supplements are well known in the art, and therefore no further description thereof is deemed necessary.

Another embodiment is directed to a system for providing optimal preconception, prenatal, pregnancy, postnatal, and/or lactation nutrition. The system includes two or more of the compositions disclosed or otherwise contemplated herein. For example, but not by way of limitation, the system includes:
(i) at least one composition produced in accordance with the presently disclosed inventive concept(s) and designed for consumption as part or all of a breakfast meal (i.e., one breakfast composition), along with
(ii) two or more other compositions, each produced in accordance with the presently disclosed inventive concept(s) and designed for consumption as part or all of a snack (i.e., two or more snack compositions).

The system further include a preconception, prenatal, pregnancy, postnatal, and/or lactation supplement, as described in greater detail herein above. The systems of the presently disclosed inventive concept(s) facilitate steady micronutrient/macronutrient intake throughout the day and ensure greater bioavailability of the micronutrients/macronutrients disposed in the compositions.

In an embodiment, one or more preconception, prenatal, pregnancy, postnatal, and/or lactation supplements are utilized in combination with the compositions and as part of the system of the presently disclosed and claimed inventive concept(s).

In an embodiment, any preconception, prenatal, pregnancy, postnatal, and/or lactation supplement known in the art can be utilized in combination with the compositions and as part of the systems of the presently disclosed and claimed inventive concept(s).

In another embodiment, the systems of the presently disclosed inventive concept(s) include one or more sets of instructions.

In another embodiment, the instructions explain how to use the system and/or how to select additional foods and/or beverages to use in combination with the compositions (and potentially preconception, prenatal, pregnancy, postnatal, and/or lactation supplement(s)) of the system.

In yet another embodiment, any type of format capable of conveying the desired information (and/or directing a user's attention to a location where said information can be found) is utilized as the instructions described or otherwise contemplated herein.

In a further embodiment, non-limiting examples of formats in which the instructions are provided include written wording and/or pictorial drawings, hardware, software, a website address, a bar code (such as but not limited to, a Quick Response (QR) or Universal Product Code (UPC)) that is readable by an imaging device and/or code reader, combinations thereof, and the like.

In an embodiment, the instructions are in the form of a consumption schedule.

In an embodiment, the instructions are in the form of a menu planner.

In another embodiment, any consumption schedule and/or menu planner formats known in the art or otherwise contemplated herein is utilized in accordance with the presently disclosed inventive concept(s).

In yet another embodiment, but not by way of limitation, the instructions provided with the systems of the presently disclosed inventive concept(s) provide an analysis of the remaining desired daily intake levels of calories/energy, macronutrient(s), and/or components of the preconception, prenatal, pregnancy, postnatal, and/or lactation nutrient bundle following consumption of the composition(s) contained in the system. Based on this determination of remaining desired daily intake levels, the instructions include one or more recommendations on other food options that can be consumed in combination with the one or more compositions (as described or otherwise contemplated herein) to provide an optimal daily nutritional profile for the preconception, prenatal, pregnant, postnatal, and/or lactating women and ensure good metabolic health therefore addition, the recommendation(s) include an evaluation of optimal consumption time(s) and order(s) of consumption of the compositions/foods to provide better absorption of the macronutrients and/or micronutrients present in compositions/foods consumed throughout the day and thus ensure the greatest bioavailability of the macronutrients and/or micronutrients. In addition, recommendation(s) regarding consumption of particular compositions/foods at various times and day parts will provide for release delay/time release nutrition so that different macronutrients and/or micronutrients can be absorbed in different parts of the gastrointestinal tract, and thus can help alleviate certain preconception, prenatal, pregnancy, postnatal, and/or lactation symptoms (i.e., nausea, vomiting, fatigue, sleeplessness, constipation, bloating, diarrhea, etc.). For example, but not by way of limitation, the effects of consuming a bundle of nutrients in the morning or at night have an important role in the absorption and toleration of the body, during preconception, prenatal, pregnancy, postnatal, and/or lactation stage. Therefore, the instructions include a recommended consumption schedule for the compositions/foods. The recommended consumption schedule includes:
(i) recommendation(s) on the order of consumption of the composition(s) and foods,
(ii) recommendation(s) on the time(s) of consumption for one or more of the composition(s)/foods (which may be in the form of actual time(s)/day part(s) or relative values that are in relation to the other composition(s)/foods to be consumed), or
(iii) meal planning recommendation(s), wherein the composition(s)/foods are separated into complete meals, meal replacements, incomplete meal components that are combined to provide a complete meal, and/or snacks.

In one embodiment, the interactive menu planner system is utilized in combination with any of the compositions, kits, and/or systems disclosed or otherwise contemplated herein.

In an embodiment, the interactive menu planner provides a way to rate the nutritional value of a menu for preconception, prenatal, pregnant, postnatal, and/or lactating women; and to ensure that the women are receiving proper nutrition specific to their needs.

In another embodiment, in the interactive menu planner system, the specificity of the nutrition is based on the stage of pregnancy and/or lactation (i.e., preconception period; first, second, or third trimester of pregnancy; postnatal period, etc.) and/or other factors (such as, but not limited to, one or more characteristics of the mother (such as, but not limited to, age, weight, body size, body composition, and/or level of physical activity) and/or particular condition(s) of the mother and/or fetus/baby, as described in detail herein above).

In another embodiment, an interactive menu planner system and methods of use thereof are described in detail in US Published Application No. US 2012/0254196, published Oct. 4, 2012; the entire contents of which are hereby expressly incorporated herein by reference. Therefore, systems and methods in accordance with the '196 published application but modified to be specific for preconception, prenatal, pregnant, postnatal, and/or lactating women based upon the specific nutritional information and compositions, kits, and methods disclosed or otherwise contemplated herein, also fall within the scope of the presently disclosed inventive concept(s).

In yet another embodiment of the presently disclosed inventive concept(s) is directed to a combination that includes the interactive menu planner system described herein above with any of the compositions, kits, nutrition systems, and/or ranges of products disclosed or otherwise contemplated herein, as described herein above and herein after.

In one embodiment of the presently disclosed inventive concept(s) is directed to a method of optimizing the nutritional needs of preconception, prenatal, pregnant, postnatal, and/or lactating women.

In an embodiment, in the method as described herein above, the specific daily caloric need or EER of preconception, prenatal, pregnant, postnatal, and/or lactating women is determined.

In another embodiment, in the method as described herein above, the specificity of the daily caloric need or EER is based on the stage of pregnancy and/or lactation (i.e., preconception period; first, second, or third trimester of pregnancy; postnatal period, etc.) and/or other factors (such as, but not limited to, one or more characteristics of the mother (such as, but not limited to, age, weight, body size, body composition, and/or level of physical activity) and/or particular condition(s) of the mother and/or fetus/baby, as described in detail herein above).

In another embodiment, the daily caloric need or EER is provided as a minimum amount of calories or energy to consume in a day or a range of optimal calories/energy to consume in a day. Based on the daily caloric need or EER (and optionally also the stage of pregnancy and/or other factors), a desired daily intake level for one or more macronutrients (i.e., protein, amino acid(s), fiber, fat, carbohydrate, etc.) is determined.

In one embodiment, based on the specific stage of pregnancy, lactation, or/and other factors; a desired preconception, prenatal, pregnancy, postnatal, and/or lactation nutrient bundle (as described in detail herein above and containing at least three preconception, prenatal, pregnancy, postnatal, and/or lactation fundamental micronutrients) is determined.

In another embodiment, the method involves the provision of one or more of the compositions described or otherwise contemplated herein. The compositions are provided simply by directing a consumer which compositions to select, purchase, and consume; alternatively, the provision of the composition(s) may be performed as part of a kit and/or a home delivery system, wherein the need for a consumer to select between multiple products is removed.

In another embodiment, the method involves the determinations of the remaining desired daily intake levels of calories and/or energy; macronutrient(s); and components of the preconception, prenatal, pregnancy, postnatal, and/or lactation nutrient bundle following consumption of such composition(s); are performed. Based on these determinations of remaining desired daily intake levels, one or more recommendations can be made on other food options that may be consumed in combination with the one or more compositions (as described or otherwise contemplated herein) to provide an optimal daily nutritional profile for the preconception, prenatal, pregnant, postnatal, and/or lactating women and ensure good metabolic health therefor.

In an embodiment, the recommendation(s) includes an evaluation of optimal consumption time(s) and order(s) of consumption of the compositions and/or foods to provide better absorption of the macronutrients and/or micronutrients present in compositions and/or foods consumed throughout the day and thus ensure the greatest bioavailability of the macronutrients and/or micronutrients.

In another embodiment, recommendation(s) regarding consumption of particular compositions and/or foods at various times and day parts will provide for release delay/time release nutrition so that different macronutrients and/or micronutrients can be absorbed in different parts of the gastrointestinal tract, and thus can help alleviate certain preconception, prenatal, pregnancy, postnatal, and/or lactation symptoms (i.e., nausea, vomiting, fatigue, sleeplessness, constipation, bloating, diarrhea, etc.). For example, but not by way of limitation, the effects of consuming a bundle of nutrients in the morning or at night may have an important role in the absorption and toleration of the body, during preconception, prenatal, pregnancy, postnatal, and/or lactation stage. Therefore, the method may include the step of providing a recommended consumption schedule for the compositions/foods. The recommended consumption schedule may include
(i) recommendation(s) on the order of consumption of the composition(s) and foods,
(ii) recommendation(s) on the time(s) of consumption for one or more of the composition(s)/foods (which may be in the form of actual time(s)/day part(s) or relative values that are in relation to the other composition(s)/foods to be consumed), or
(iii) meal planning recommendation(s), wherein the composition(s)/foods are separated into complete meals, meal replacements, incomplete meal components that are combined to provide a complete meal, and/or snacks.

In one embodiment of the presently disclosed inventive concept(s) is directed to a range of preconception, prenatal, pregnancy, postnatal, and/or lactation food and/or beverage products, each having an optimal nutritional profile that is specific for a particular stage of pregnancy/lactation and/or other factors (as described in greater detail herein).

In an embodiment, the range includes a plurality of different compositions, kits, and/or systems produced as described herein above. That is, a plurality of different compositions of food and/or beverage products that each includes a preconception, prenatal, pregnancy, postnatal, and/or lactation fundamental nutrient bundle, or a plurality of systems/kits containing same, is provided. The plurality of different compositions differs in at least one of the following:
(a) the types of food and/or beverage products provided;
(b) the contents of the preconception, prenatal, pregnancy, postnatal, and/or lactation fundamental nutrient bundle present in the compositions; and/or
(c) the dosage level of one or more substances present in the preconception, prenatal, pregnancy, postnatal, and/or lactation fundamental nutrient bundle.

In another embodiment, as described herein above, the presence and/or dosage levels of particular nutrients in the range of products can be varied, depending on the stage of pregnancy/lactation and/or other factors, as appropriate. That is, the presence and/or dosage levels of particular nutrients may vary between the preconception period; the first, second, and/or third trimesters of pregnancy; and the periods of lactation and/or postnatal weight loss. For example, but not by way of limitation, the nutrient lutein may be included in the nutrition system targeted for lactating/breastfeeding mothers, but not in the nutrition systems targeted for women during pregnancy.

In one embodiment, at least a portion of the range of products is shelf-stable.

In an embodiment, at least a portion of the range of products is perishable (i.e., require refrigerated and/or frozen storage).

In another embodiment, the presence of particular nutrients in the range of products can be varied depending one or more characteristics of a mother (such as, but not limited to, age, weight, body size, body composition, and/or level of physical activity) while still ensuring that the mother is receiving balanced nutrition in addition to a proper amount of weight gain/loss (i.e., assisting an undernourished mother in gaining the proper amount of weight during pregnancy, minimizing the weight gain of an overweight pregnant mother, and/or assisting with postnatal weight loss of a lactating mother). In addition, the presence and/or dosage levels of particular nutrients vary in response to one or more of the following:
(i) poor maternal dietary intake of nutrients (which may occur during any of the preconception, prenatal, pregnancy, postnatal, and/or lactation periods);
(ii) inadequate or unhealthy dietary patterns (i.e. low consumption of fruits, vegetable, whole grains, low-fat dairy, lean meat; and high consumption of foods with excess calories, saturated fat, added sugars, sodium, and minimal nutritional value);
(iii) one or more pre-pregnancy existing health conditions (i.e., obesity, diabetes, etc., and including genetically and/or environmentally related conditions);
(iv) increased and or varying nutritional needs during pregnancy and/or lactation;
(v) common symptoms that may arise during pregnancy and/or lactation (i.e., nausea, vomiting, fatigue, sleeplessness, constipation, bloating, diarrhea, etc.); and/or
(vi) one or more pregnancy-induced health conditions (i.e., gestational diabetes, anemia, hypertension, etc., and including genetically and/or environmentally related conditions).

In one embodiment of the presently disclosed inventive concept(s) is directed to a method of providing a range of preconception, prenatal, pregnancy, postnatal, and/or lactation food and/or beverage products.

In an embodiment, in the method, a range that includes a plurality of different compositions, kits, and/or systems, produced as described in detail herein above, are provided.

In an embodiment, at least two of the plurality of different compositions (present alone and/or as part of a kit and/or a system) differ in at least one of the following:
(a) the types of food and/or beverage products provided,
(b) the contents of the preconception, prenatal, pregnancy, postnatal, and/or lactation fundamental nutrient bundle, and/or
(c) the dosage level of one or more substances present in the preconception, prenatal, pregnancy, postnatal, and/or lactation fundamental nutrient bundle.

The range of compositions, kits, and/or systems is displayed for perusal by consumers, so that a consumer can select one or more products from the range that are directed to their specific stage, conditions, and/or factors (as described herein above). The method includes the step of providing guidance/recommendation(s) to a consumer. The guidance and/or recommendation(s) includes, but is not limited to:
(1) recommendation(s) on the selection of one or more products from the range;
(2) recommendation(s) on other food options that may be consumed in combination with the selected product(s); and/or
(3) recommendation(s) regarding a consumption schedule for the particular product(s), either alone or in combination with other foods. Recommendation(s) regarding a consumption schedule includes, but are not limited to:
   (i) recommendation(s) on the order of consumption of the product(s) and foods,
   (ii) recommendation(s) on the time(s) of consumption for one or more of the product(s)/foods (which may be in the form of actual time(s)/day part(s) or relative values that are in relation to the other product(s)/foods to be consumed), or
   (iii) meal planning recommendation(s), wherein the product(s)/foods are separated into complete meals, meal replacements, incomplete meal components that are combined to provide a complete meal, and/or snacks.

In one embodiment, the guidance and/or recommendation(s) assumes the form of any of the instructions described or otherwise contemplated herein. Examples of acceptable formats in which the guidance and/or recommendation(s) provided include, but are not limited to, written wording and/or pictorial drawings, hardware, software, a website address, a bar code (such as but not limited to, a Quick Response (QR) or Universal Product Code (UPC)) that is readable by an imaging device/code reader, combinations thereof, and the like.

In another embodiment, the instructions contain static information, or the instructions can be in an interactive form.

In an embodiment, the guidance and/or recommendation(s) are provided in an interactive form, the guidance and/or recommendation(s) are further defined as a device that calculates the values and/or recommendations discussed herein above based upon the various types of information related to the composition(s), the stage of pregnancy/lactation, characteristic(s) of the mother, and/or conditions/issues of the mother/fetus/infant (as described in detail herein above) input into the device.

In another embodiment, any device capable of calculating one or more values and/or recommendations as described herein above based on the input of multiple variables may be utilized in accordance with the presently disclosed inventive concept(s). Non-limiting examples of devices that may be utilized include simple, manually manipulated devices (such as, but not limited to, slide rule-type devices, nomogram-type devices, sliding window(s)-type devices, as well as any other type of chart and/or diagram that requires manual manipulation to determine a calculated value) as well as logic devices (such as, but not limited to, software and/or hardware-type devices, such as a microprocessor, microcontroller, application specific integrated circuit, field programmable gate array or the like).

In an embodiment, the guidance and/or recommendation(s) is in the form of a consumption schedule.

In an embodiment, the guidance and/or recommendation is in the form of a menu planner.

In an embodiment, any consumption schedule and/or menu planner formats known in the art or otherwise contemplated herein can be utilized in accordance with the presently disclosed inventive concept(s).

In an embodiment, the guidance and/or recommendation(s) are provided on the product packaging itself, or the guidance and/or recommendation(s) is provided separately.

In an embodiment, wherein the guidance and/or recommendation(s); for example, but not by way of limitation, is provided as part of one or more display(s) in which at least a portion of the range of products is contained, or is attached or otherwise associated with one or more display(s) containing at least a portion of the range of products.

In an embodiment, the guidance and/or recommendation(s) is provided in the form of an external device (such as but not limited to, a kiosk) that is disposed in the general vicinity of at least a portion of the range of products.

In an embodiment, the guidance and/or recommendation(s) contain static information.

In an embodiment, the guidance and/or recommendation(s) are in an interactive form (as described in detail herein above).

In an embodiment, the presently disclosed inventive concept(s) are directed to an assembly that includes any of the ranges of preconception, prenatal, pregnancy, postnatal, and/or lactation food and/or beverage products described or otherwise contemplated herein.

In another embodiment, the assembly further includes any of the guidance and/or recommendation(s) described or otherwise contemplated herein.

In yet another embodiment, optionally and/or in addition thereto, the assembly includes one or more preconception, prenatal, pregnancy, postnatal, and/or lactation supplements (including but not limited to, a range of preconception, prenatal, pregnancy, postnatal, and/or lactation supplements).

In still yet another embodiment, optionally and/or in addition thereto, the assembly further includes at least one display unit in which at least a portion of the range of products (and/or preconception, prenatal, pregnancy, postnatal, and/or lactation supplements) is displayed.

In an embodiment, the combinations of method steps described herein above are performed simultaneously, wholly, or partially sequentially. In addition, the exemplary sequences of method steps provided herein above are for the purposes of illustration only; it will be understood that the individual steps, as well as the particular order of steps, may vary, and the sequence of steps may be performed in any order, so long as the materials and packages described herein are capable of functioning in accordance with the presently disclosed inventive concept(s).

Thus, in accordance with the presently disclosed inventive concept(s), there has been provided a preconception, prenatal, pregnancy, postnatal, and/or lactation food and drink optimal nutrition system, compositions and kits for use therein, as well as methods of producing and using same, that fully satisfy the objectives and advantages set forth hereinabove. Although the presently disclosed inventive concept(s) has been described in conjunction with the specific language set forth hereinabove, it is evident that many alternatives, modifications, and variations will be apparent to those skilled in the art. Accordingly, it is intended to embrace all such alternatives, modifications, and variations that fall within the spirit and broad scope of the presently disclosed inventive concept(s). Changes can be made in the construction and the operation of the various components, elements, and assemblies described herein, as well as in the steps or the sequence of steps of the methods described herein, without departing from the spirit and scope of the presently disclosed inventive concept(s).

Solely for the purposes of space, the term “about” was omitted in front of each number appearing in Table 1; however, it will be understood that slight variations can occur in the values/value ranges listed in Table 1. The scope of the presently disclosed inventive concept(s) encompasses not only the specific, finite values/value ranges listed in Table 1 (i.e., 7.1 g protein, 0-130 mg calcium, etc.) but also slight variations in each of the values/value ranges listed therein (i.e., about 7.1 g protein, a range from about 0 mg to about 130 mg calcium, etc.).

TABLE 1

| | 2014 | | | | | | | | | | | |
|---|---|---|---|---|---|---|---|---|---|---|---|---|
| | Proposed | 2% DV | | | | | | | | | | |
| | RDI for | could | | | DRI Tolerable | | Amount | | | | | |
| | DV for | appear in | | Maximum | Upper Limit | | per | | | | Amount per | |
| | preg/lact | nutrition | 10% DV | allowed | preg—not a | | Serving | | Amount per | | serving in | Sources |
| | (100% | facts | claimable | in foods | level to be | | in FOOD | | serving in | | SUPPLE- | of the |
| Nutrient | DV) | panel | amount | per FDA | provided in food | | 10% DV | | RTE Cereal | | MENT | Nutrient |
| Protein g | 71 | 1.42 | 7.1 | n/a | | | 7 | g | 7 | g | n/a | varies |
| Fiber g | 28 | 0.56 | 2.8 | source | | | 2.8 | g | 3 g | (10%) | n/a | varies |
| | | | | dependent | | | (3 | g) | | | | |
| Choline mg | 550 | 11 | 55 | GRAS | 3000-3500 | mg | 55 | mg | 110 | (20%) | 100% | choline |
| | | | | | | | | | | | | bitartrate, |
| | | | | | | | | | | | | choline |
| | | | | | | | | | | | | chloride |
| DHA | None | Any amount can be | | GRAS | none | | 30 | mg | 30 | mg | 200-300 mg | algal oil, |
| | | added and listed on | | | | | | | | | | tuna oil |
| Vitamin D mcg | 15 | 0.3 | 1.5 | 350 IU/ | 100 | mcg | 1.5 | mcg | 1.5 | (10%) | 100% | vit D2 or |
| | | | | 100 g cereal; | | | | | | | | vit D3 |
| | | | | 90 IU/ | | | | | | | | (chole- |
| | | | | 100 g grains | | | | | | | | calciferol) |
| Folate mcg | 600 | 12 | 60 | GMP | 800-1,000 | mcg | 60 | mcg | 60 mcg | (10%) | 100% | folic acid |
| | | | | in foods | | | | | | | | |
| | | | | for special | | | | | | | | |
| | | | | dietary use; | | | | | | | | |
| | | | | 400 mcg | | | | | | | | |
| | | | | in cereal | | | | | | | | |
| Calcium mg | 1300 | 26 | 130 | GRAS | 2500-3000 | mg | 130 | mg | 0-130 | (10%) | 25% (need | calcium |
| | | | | | | | | | | | to know | phosphates |
| | | | | | | | | | | | what is | |
| | | | | | | | | | | | achievable) | |
| Magnesium mg | 400 | 8 | 40 | GRAS | 350 | mg | 40 | mg | 40 mg | (10%) | 25% (need | magnesium |
| | | | | | supplements | | | | | | to know | carbonate, |
| | | | | | only | | | | | | what is | chloride, |
| | | | | | | | | | | | achievable) | hydroxide, |
| | | | | | | | | | | | | oxide, |
| | | | | | | | | | | | | phosphate, |
| | | | | | | | | | | | | stearate, |
| | | | | | | | | | | | | sulphate |
| Iron mg | 27 | 0.54 | 2.7 | | 45 | mg | 0 | mg | 8.4 | (30%) | 100% | electrolytic |

| | | | | WIC | | | iron, |
|---|---|---|---|---|---|---|---|
| | | | | | | | ferrous |
| | | | | | | | sulphate, |
| | | | | | | | ferrous |
| | | | | | | | fumarate |
| Vitamin E mg | 19 | 0.38 | 1.9 | 1.9 mg | (10%) | 100% | |
| Vitamin K mcg | 90 | 1.8 | 9 | | | | |
| Thiamin mg | 1.4 | 0.028 | 0.14 | 0.35 | (25%) | 100% | |
| Riboflavin mg | 1.6 | 0.032 | 0.16 | 0.4 | (25%) | 100% | |
| Niacin mg | 18 | 0.36 | 1.8 | 4.5 | (25%) | 100% | |
| Vitamin B6 mg | 2 | 0.04 | 0.2 | 0.5 | (25%) | 100% | |
| Vitamin B12 mcg | 2.8 | 0.056 | 0.28 | 0.7 | (25%) | 100% | |
| Biotin mcg | 35 | 0.7 | 3.5 | | | 100% | |
| Pantothenic | 7 | 0.14 | 0.7 | 1.75 | (25%) | 100% | |
| Acid mg | | | | | | | |
| Phosphorus mg | 1250 | 25 | 125 | | | | |
| Iodine mcg | 290 | 5.8 | 29 | | | 100% | |
| Zinc mg | 13 | 0.26 | 1.3 | 1.3 | (10%) | 100% | zinc |
| | | | | | | | sulfate |

| | | | | | | | |
|---|---|---|---|---|---|---|---|
| Selenium mcg | 70 | 1.4 | 7 | | | | |
| Copper mg | 1.3 | 0.026 | 0.13 | | | 100% | |
| Manganese mg | 2.6 | 0.052 | 0.26 | | | | |
| Chromium mcg | 45 | 0.9 | 4.5 | | | | |
| Molybdenum mcg | 50 | 1 | 5 | | | | |
| Chloride mg | 2300 | 46 | 230 | | | | |
| Potassium mg | 5100 | 102 | 510 | | | | |
| Vitamin A mcg | 1300 | 26 | 130 | | | 100% as | beta- |
| RAE | | | | | | beta-carotene | carotene |
| Vitamin C mg | 120 | 2.4 | 12 | GRAS to | amount | 100% | ascorbic |
| | | | | GMP levels | relative | | acid |
| | | | | | to iron | | |

Using our dietary intake analysis, we have chosen nutrients for our products that women are not getting enough of, but fortifying to a level that is unlikely to result in our target consumers increasing their intake of the nutrients to amounts that exceed the IOM DRI Upper Levels.

In at least one embodiment, Nutrition Guidelines include:

| Nutrient | GOAL | MINIMAL |
|---|---|---|
| Calories | Under 150 calories per serving for bites | Everything <200 calories (will require |
| | at 30 g serving size | competitive assessment to confirm |
| | Under 200 calories per serving for bars at | team comfort) |
| | 40 g serving size | |
| | Under 200 calories for RTE cereal at a | |
| | 55 g serving size | |
| Total Fat | ≦3 g/RACC and per 50 g if the RACC | ≦3 g/RACC and per 50 g if the RACC |
| | is ≦30 g | is ≦30 g |
| | If product is at least 51% whole grain, | If product is at least 51% whole |
| | there will be additional fat from the whole | grain, there will be additional fat from |
| | grain and it might not be able to meet | the whole grain and it might not be |
| | above. For these products, total fat may | able to meet above. For these |
| | be <6.5 g per RACC. | products, total fat may be <6.5 g per |
| | Product with 11 g nuts/seeds or more per | RACC. |
| | serving may have up to 13 g fat per serving | Product with 11 g nuts/seeds or more |
| | | per serving may have up to 13 g fat |
| | | per serving |
| Saturated Fat | 1 g or less per RACC and 15% or less of | ≦15% DV/serving = ≦3 g/serving |
| | calories from saturated fat meets the FDA | (adequate NF) |
| | definition of low saturated fat and this is | |
| | ideal. | |
| | For products that have 11 g nuts/seeds or | |
| | more per serving, use 3 g or less sat fat per | |
| | serving | |
| Trans Fat | 0 g/serving. No added trans fat | 0 g/serving. No added trans fat |
| Cholesterol | ≦60 mg/RACC and per serving | ≦60 mg/RACC and per serving |
| Sodium | ≦7.5% DV/serving = ≦180 mg/serving | ≦360 mg/RACC and serving |
| Added Sugars* | ≦20% calories (unless determined to be a | ≦25% OF CALORIES/serving |
| | natural source of sugar such as fruit) | |
| Good Source | Contains at least 10% of DV/RACC for | Contains at least 10% of DV/RACC |
| | one or more of the following: vitamins A, | for one or more of the following: |
| | C, calcium, iron, protein, or fiber (this is | vitamins A, C, calcium, iron, protein, |
| | FDA Healthy requirement) | or fiber |
| | | OR a good source of one of the |
| | | identified pregnancy bundle nutrients |
| | | such as choline, potassium, |
| | | magnesium folic acid (cannot claim |
| | | healthy) |

The foregoing description of various aspects of the invention has been presented for purposes of illustration and description. Embodiments and/or features therein may be freely combined with one another. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A composition, comprising at least two food and/or beverage product designed specifically for consumption during one or more periods spanning from preconception through postnatal lactation, the at least one food and/or beverage product comprising:
a preconception/prenatal/postnatal fundamental nutrient bundle that comprises at least three preconception/prenatal/postnatal fundamental micronutrients;
at least one macronutrient; and
an metabolic health profile that includes one or more of: less than or equal to 20% calories from added sugar; less than 3 g fat; 0 g trans fat; less than 60 mg cholesterol; and less than 300 mg sodium;
wherein each fundamental nutrient is present in the composition at a level in a range of from about 0.1% DV to about 100% DV; and
wherein the at least one macronutrient is selected from the group consisting of protein, at least one amino acid, and carbohydrate.

2. The composition of claim 1, further defined as being sized and proportioned to serve as a complete meal, as a meal replacement, as an incomplete meal component, and/or as a snack.

3. The composition of claim 1, wherein each of the at least three preconception/prenatal/postnatal fundamental micronutrients present in the preconception/prenatal/postnatal fundamental nutrient bundle is selected from the group consisting of docosahexaenoic acid (DHA), choline, folic acid, calcium, vitamin C, vitamin D, vitamin E, magnesium, potassium, lutein, iodine, iron, fiber, vitamin K, progesterone, dehydroepiandrosterone (DHEA), Coenzyme Q10 (CoQ10), analogs and derivatives thereof, and various combinations thereof.

4. The composition of claim 1, wherein each of the at least three preconception/prenatal/postnatal fundamental micronutrients present in the preconception/prenatal/postnatal fundamental nutrient bundle is selected from the group consisting of docosahexaenoic acid (DHA), choline, folic acid, calcium, vitamin C, vitamin D, vitamin E, and fiber, analogs and derivatives thereof, and various combinations thereof.

5. The composition of claim 1, further comprising at least one probiotics.

6. The composition of claim 1, further comprising at least one prebiotics.

7. The composition of claim 1, further comprising at least one of: herbs, herb extracts, or combinations thereof.

8. The composition of claim 1, further comprising at least one of lutein, zeaxanthin, or combinations thereof.

9. The composition of claim 1, wherein a dosage level of each preconception/prenatal/postnatal fundamental nutrient is specific for at least one factor selected from the group consisting of:
(a) at least one stage selected from the group consisting of a preconception period, a first trimester of pregnancy, a second trimester of pregnancy, a third trimester of pregnancy, a lactation period, a period of postnatal weight loss, and combinations thereof;
(b) at least one characteristic of a mother selected from the group consisting of age, weight, body size, body composition, level of physical activity, and combinations thereof;
(c) at least one particular condition of the mother and/or fetus/baby; and
(d) any combination of two or more of (a)-(c).

10. The composition of claim 1, further defined as providing at least one skin health benefit when consumed during one of the periods spanning from preconception through postnatal lactation.

11. The composition of claim 1, wherein the at least one food and/or beverage product is shelf-stable.

12. A kit, comprising:
at least two compositions selected from the group consisting of those claimed in any one of claims 1-11.

13. The kit of claim 12, further comprising three or more compositions, wherein the compositions are different.

14. The kit of claim 12, further comprising at least one set of instructions.

15. The kit of claim 14, wherein the instructions are in the form of at least one consumption schedule and/or at least one menu planner.

16. The kit of claim 12, further comprising at least one prenatal and/or postnatal supplement.

17. A method of optimizing the nutritional needs of a preconception/prenatal/postnatal woman, the method comprising the steps of:
(i) determining a specific daily caloric need and/or estimated energy requirement (EER) of a preconception/prenatal/postnatal woman based on at least one factor selected from the group consisting of:
(a) at least one stage selected from the group consisting of a preconception period, a first trimester of pregnancy, a second trimester of pregnancy, a third trimester of pregnancy, a lactation period, a period of postnatal weight loss, and combinations thereof;
(b) at least one characteristic of a mother selected from the group consisting of age, weight, body size, body composition, level of physical activity, and combinations thereof;
(c) at least one particular condition of the mother and/or fetus/baby; and
(d) any combination of one or more of (a)-(c);
(ii) determining a desired daily intake level for one or more macronutrients based on the one or more of specific factors (a)-(d);
(iii) determining a desired preconception/prenatal/postnatal nutrient bundle comprising at least three preconception/prenatal/postnatal fundamental micronutrients, based on the one or more specific factors (a)-(d); and
(iv) providing, based upon the determinations of (i)-(iii), at least one composition of any of claims 1-6.

18. The method of claim 17, further comprising the step of providing, based upon the determinations of (i)-(iii), at least one prenatal and/or postnatal supplement.

19. The method of claim 17, further comprising the step of providing, based upon the determinations of (i)-(iii), at least fundamental nutrient to correct a nutritional gap.

20. The method of claim 17, further comprising the step of providing, based upon the determinations of (i)-(iii), at least fundamental nutrient to mitigate symptoms of pregnancy.
